(19) United States
(12) Patent Application Publication
(10) Pub. No.: US 2026/0211536 A1
(43) Pub. Date: Jul. 23, 2026

(54) ELECTRONIC DEVICE AND VISUAL INTERFACE COLOR SETTING METHOD THEREOF

(71) Applicant: ASUSTeK COMPUTER INC., Taipei City (TW)

(72) Inventors: Ruei-Yan Chen, Taipei City (TW); Meng-Huan Liou, Taipei City (TW)

(73) Assignee: ASUSTeK COMPUTER INC., Taipei City (TW)

(21) Appl. No.: 19/438,670

(22) Filed: Jan. 2, 2026

(30) Foreign Application Priority Data
Jan. 22, 2025 (TW) 114102724

(51) Int. Cl. G06F 3/0484; G06F 16/334

(52) U.S. Cl. CPC G06F 3/0484; G06F 16/3347

(57) ABSTRACT

An electronic device and a visual interface color setting method thereof are provided. The method is adapted to the electronic device including a display. The display is configured to display a visual operation interface, and the method includes the following steps. User input information is received. A search semantic vector is generated based on the user input information using a text embedding model. Based on the search semantic vector and respective color semantic vectors of multiple predetermined colors, at least one theme color is selected from the predetermined colors. Based on the at least one theme color, an interface color setting function of the visual operation interface is executed.

### CROSS-REFERENCE TO RELATED APPLICATION

This application claims the priority benefit of Taiwan application serial no. 114102724, filed on Jan. 22, 2025. The entirety of the above-mentioned patent application is hereby incorporated by reference herein and made a part of this specification.

### BACKGROUND

### Technical Field

The disclosure relates to an electronic device and a visual interface color setting method.

### Related Art

With the advancement of technology, powerful performance and rich applications have made electronic devices indispensable items in modern daily life. Generally, users may set the visual interface colors of these electronic devices according to their preferences, thereby enhancing the aesthetic appeal of the electronic devices and achieving device personalization. At present, users can only select from a set of predefined color schemes, which not only requires time to browse through the available options but may also fail to meet the diverse preferences of different users. Alternatively, users can choose a preferred primary color and then generate a system-wide color scheme either automatically or manually. Although this approach offers greater flexibility, it still requires considerable effort in selecting colors. Moreover, if users lack sufficient knowledge or intuitive associations with colors, they may find it difficult to choose a color scheme that aligns with their desired visual impression at that moment.

### SUMMARY

The disclosure provides a visual interface color setting method, adapted to an electronic device including a display. The display is configured to display a visual operation interface, and the method includes the following steps. A user input information is received. A search semantic vector is generated based on the user input information through a text embedding model. At least one theme color is selected from multiple preset colors according to the search semantic vector and color semantic vectors of the multiple preset colors. An interface color setting function of the visual operation interface is executed according to the at least one theme color.

The disclosure also provides an electronic device, which includes an input device, a display, a storage device, and a processor. The storage device records multiple instructions, and the processor is coupled to the input device, the display, and the storage device, executing the instructions to perform the following operations. A user input information is received through the input device. A search semantic vector is generated based on the user input information through a text embedding model. At least one theme color is selected from multiple preset colors according to the search semantic vector and color semantic vectors of the multiple preset colors. An interface color setting function of the visual operation interface is executed according to the at least one theme color.

Based on the above, in the disclosure, a text embedding model may be utilized to generate a search semantic vector of the user input information, and the search semantic vector is compared with at least one color semantic vectors corresponding to each preset color to select at least one theme color from multiple preset colors that matches the user input information. Then, an interface color setting function of the visual operation interface may be executed according to the theme color. As a result, the color scheme of the visual operation interface is no longer limited to fixed colors, but can select a color scheme that better matches the user's preferences based on the semantics of the user input information, thereby greatly enhancing the convenience and flexibility of interface color setting.

### BRIEF DESCRIPTION OF THE DRAWINGS

FIG. 1 is a schematic diagram of an electronic device according to an embodiment of the disclosure.

FIG. 2 is a flowchart of a visual interface color setting method according to an embodiment of the disclosure.

FIG. 3 is a schematic diagram of a visual interface color setting method according to an embodiment of the disclosure.

FIG. 4 is a flowchart of a visual interface color setting method according to an embodiment of the disclosure.

FIG. 5 is a flowchart of selecting a theme color according to an embodiment of the disclosure.

FIG. 6 is a flowchart of selecting a theme color according to an embodiment of the disclosure.

### DESCRIPTION OF THE EMBODIMENTS

Some embodiments of the disclosure will now be described in detail with reference to the accompanying drawings. When the same element symbols appear in different drawings, they will be considered as the same or similar elements. These embodiments are only part of the invention and do not disclose all possible embodiments of the invention. More precisely, these embodiments are only examples of the devices and methods in the scope of claims of the disclosure.

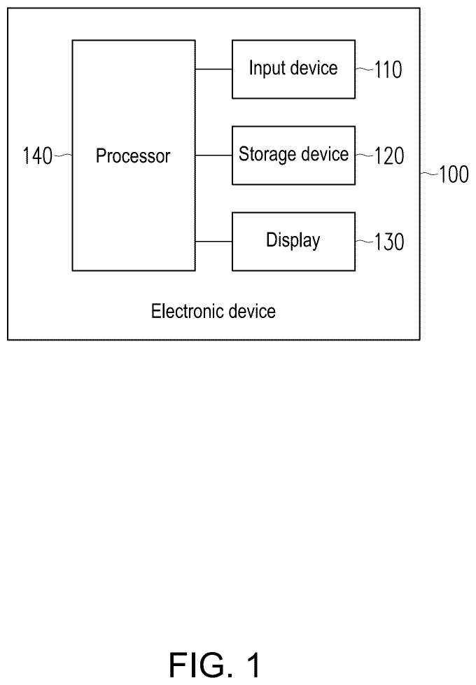

Referring to FIG. 1, the electronic device 100 of the embodiment may be, for example, a smartphone, tablet computer, laptop computer, or other electronic device capable of displaying a visual operation interface, but the disclosure is not limited thereto. The electronic device 100 includes an input device 110, a storage device 120, a display 130, and a processor 140, whose functions are described as follows.

The input device 110 is configured to receive user input information, such as a touch device, microphone, keyboard, or mouse, etc. The user input information may be text input or voice input.

The display 130 may be, for example, a Liquid Crystal Display (LCD), Light-Emitting Diode (LED) display, Field Emission Display (FED), Organic Light-Emitting Diode (OLED) display, or other types of displays, which is not limited in the disclosure.

The storage device 120 is configured to store files, images, commands, program codes, software modules, and other data. It may be, for example, any form of fixed or removable random access memory (RAM), read-only memory (ROM), flash memory, hard disk or other similar devices, integrated circuits or combinations thereof.

The processor 140 may be, for example, a Central Processing Unit (CPU), application processor (AP), or other programmable general-purpose or special-purpose microprocessor, Digital Signal Processor (DSP), programmable controller, Application Specific Integrated Circuits (ASIC), Programmable Logic Device (PLD), Graphics Processing Unit (GPU), or other similar devices or combinations of these devices. The processor 140 may execute program codes, software modules, instructions, etc. stored in the storage device 120 to implement the visual interface color setting method of the disclosure.

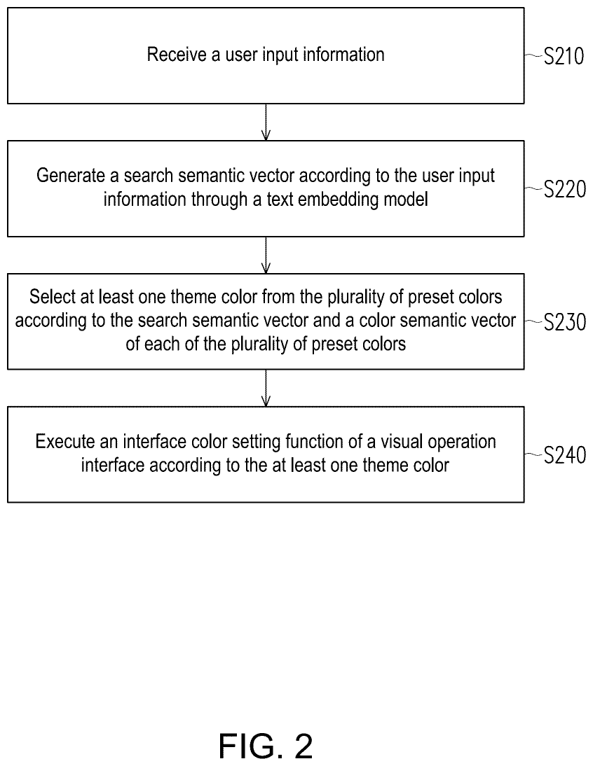

Referring to FIG. 1 and FIG. 2, the method of the embodiment is applicable to the electronic device 100 in the aforementioned embodiment. The following will explain the detailed steps of the visual interface color setting method of the embodiment in conjunction with the various components in the electronic device 100.

In step S210, the processor 140 may receive user input information through the input device 110. For example, the user may operate the input device 110 to input user information in an input field of the user operation interface displayed on the display 130. Alternatively, the user may speak the user input information, and the processor 140 may receive voice input through the input device 110. The user input information may be a single word or a combination of multiple words, which is not limited in the disclosure. The user input information may be an unformatted natural language command.

For example, the user input information may be the user's mood or feelings. Alternatively, the user input information may be something the user is interested in. Or, the user input information may be sentences from articles or poems that the user likes. Furthermore, the user input information may include holiday names. For instance, the user input information may be “Christmas” or “Christmas is coming soon”.

In step S220, the processor 140 may generate a search semantic vector based on the user input information through a text embedding model. Specifically, the processor 140 may input the user input information into the text embedding model, such that the text embedding model output a search semantic vector of the user input information. The text embedding model may be configured to convert input text into a semantic feature vector in a multi-dimensional feature space. More specifically, the text embedding model can be configured to transform text (such as words, phrases, sentences, or paragraphs) into a vector representation that can capture the semantic features of the input text. In different embodiments, the text embedding model may be, BERT (Bidirectional Encoder Representations from Transformers) model, GPT (Generative Pre-trained Transformer) model, Bag-of-Words Model, CLIP (Contrastive Language-Image Pretraining) model, or USE (Universal Sentence Encoder) model, etc.

In step S230, the processor 140 may select at least one theme color from a plurality of preset colors based on the search semantic vector and the color semantic vector of each of the preset colors. The number of the preset colors may be set according to actual applications; the disclosure does not limit this. These preset colors may belong to a first color system. The aforementioned first color system may be, for example, the Munsell Color System, but it is not limited thereto.

In some embodiments, the processor 140 may divide the 360° range of hue into 36 equal parts by fixing the value and chroma, and then combine light and dark colors to generate 72 preset colors. Additionally, the processor 140 may set black and white as two additional preset colors, thus ultimately defining 74 preset colors.

In some other embodiments, the processor 140 may determine multiple preset colors according to color systems defined in professional art books, online resources, or other authoritative literature. In some embodiments, the processor 140 may perform color model conversion on multiple other preset colors in a second color system to obtain multiple preset colors in the first color system. For example, the processor 140 may convert multiple other preset colors belonging to the RGB color system in professional literature to multiple preset colors in the Munsell Color System (i.e., HCV color space).

In some embodiments, the processor 140 may determine the semantic similarity between the search semantic vector and at least one color semantic vector of each preset color. Specifically, each preset color may be associated with one or more color semantic vectors, and the one or more color semantic vectors of each preset color are determined based on the color description text(s) of each preset color. For example, the processor 140 may calculate cosine similarity, Euclidean Distance, or Manhattan Distance to generate the semantic similarity between two semantic feature vectors.

In some embodiments, based on the semantic similarity between the search semantic vector and at least one color semantic vector of each preset color, the processor 140 may determine some color semantic vectors that are semantically closer to the search semantic vector, thereby selecting at least one theme color that is semantically closer to the search semantic vector from multiple preset colors. For example, the processor 140 may set a preset threshold for semantic similarity to filter out theme colors with semantic similarity higher than the preset threshold. Alternatively, by sorting the similarities of all color semantic vectors, the processor 140 may select the top-ranked preset colors as the theme colors.

In step S240, the processor 140 may execute an interface color setting function of the visual operation interface based on at least one theme color. The visual operation interface may be an application interface or a system operation interface, etc.

In some embodiments, the processor 140 may provide one or more system color schemes based on one or more theme colors for the user to choose from. After receiving a selection command for a certain system color scheme, the processor 140 may configure the colors of the visual operation interface according to the corresponding theme color. For example, the processor 140 may adjust the background color or border color of user operation elements (such as buttons, switches, sliders, or drop-down menus) in the visual operation interface to the theme color.

From this, it can be seen that based on the dynamic information provided by the user (i.e., user input information), a text embedding model service can be utilized to further understand the user's preferences. This enables the system to proactively suggest theme colors and corresponding color schemes that the user is more likely to favor.

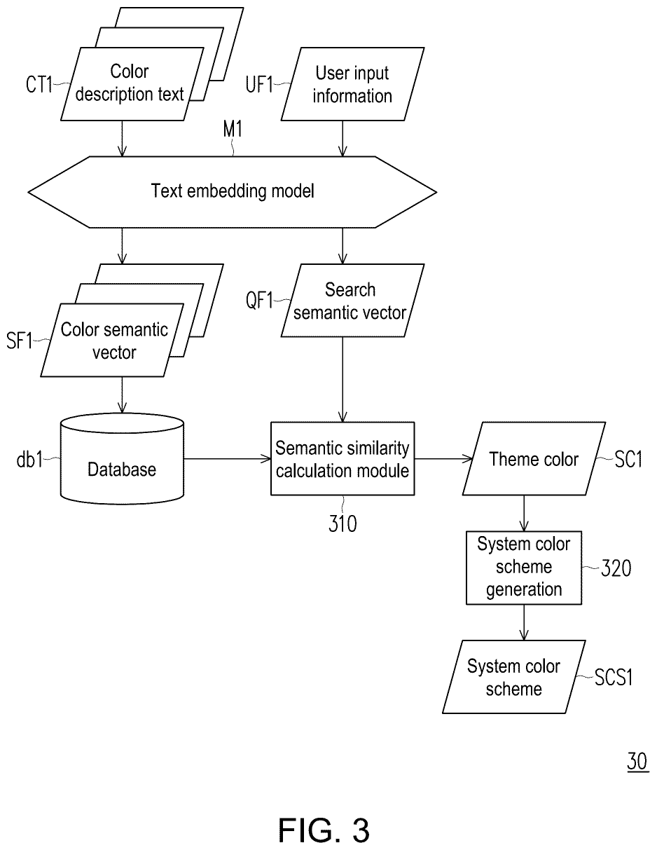

Referring to FIG. 3, which is a schematic diagram of a visual interface color setting system according to an embodiment of the disclosure. The disclosure proposes a visual interface color setting system 30 based on text embedding model and semantic analysis, which may utilize user input information to generate a search semantic vector, and through matching with color semantic vectors of preset colors, finally generate a system color scheme that matches the semantics of the user input information.

In an embodiment, the visual interface color setting system 30 includes a text embedding model M1, a database db1, a semantic similarity calculation module 310, and a system color scheme generation module 320. The text embedding model M1 is configured to processing the user input information UF1 and one or more color description texts CT1 of each preset color, converting them into a search semantic vector QF1 and multiple color semantic vectors SF1 respectively. The database db1 is configured to store one or more color semantic vectors SF1 of each preset color, serving as a basis for subsequent semantic similarity calculation.

The text embedding model M1 may generate a search semantic vector QF1 based on the user input information UF1. This search semantic vector QF1 can accurately represent the semantic features of the user input information, facilitating semantic comparison with the color description texts CT1 of preset colors. On the other hand, the color description texts CT1 of preset colors, such as “bright red” or “soft green”, are also processed by the text embedding model M1 to generate corresponding color semantic vectors SF1. These color semantic vectors SF1 are stored in the database db1.

In the semantic similarity calculation stage, the semantic similarity calculation module 310 compares the semantic similarity between the search semantic vector QF1 and each color semantic vector SF1 in the database db1. In some embodiments, the semantic similarity calculation module 310 may filter out a theme color SC1 that match the user input information UF1 based on a preset threshold of semantic similarity. Alternatively, the semantic similarity calculation module 310 may select several preset colors with the highest similarity as theme colors SC1 based on the ranking of semantic similarity.

When the theme color SC1 is determined, the system color scheme generation module 320 may generate a system color scheme SCSI based on this theme color SC1. In an embodiment, the electronic device 100 may apply the theme color to UI elements such as the background, buttons, and text of the visual operation interface to ensure the harmony and consistency of the overall visual design. Furthermore, the system color scheme generation module 320 may further refine the color scheme according to the application scenario, such as adjusting brightness, contrast, or adding gradient effects.

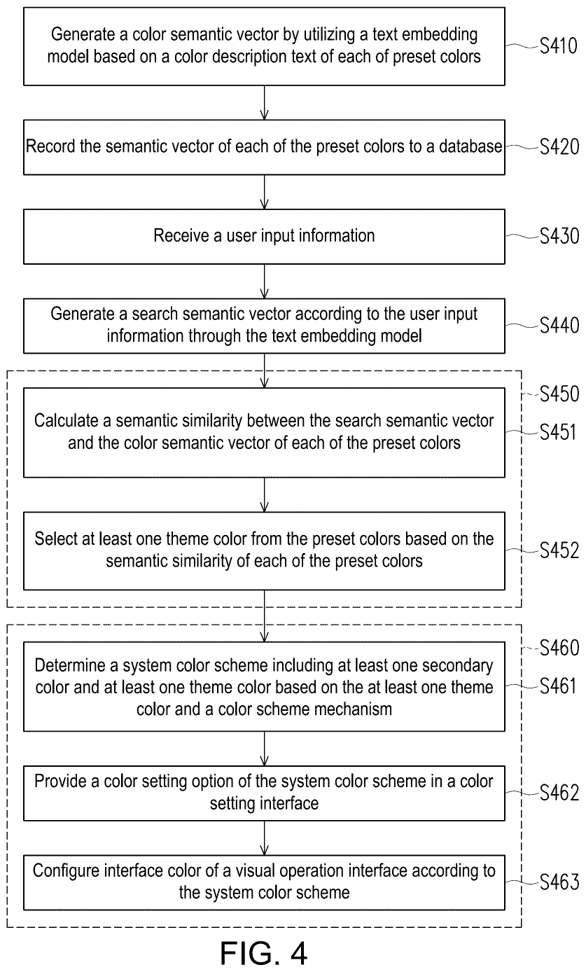

Referring to FIG. 1 and FIG. 4, the method of the embodiment is adapted to the electronic device 100 in the above-mentioned embodiment. The following will explain the detailed steps of the visual interface color setting method of the embodiment in conjunction with the various components in the electronic device 100.

In step S410, the processor 140 may generate color semantic vectors by utilizing a text embedding model based on a color description text of each of preset colors. The processor 140 may input the color description texts of each preset color into the text embedding model to generate corresponding color semantic vectors. The color description text may include color names, feelings evoked, color temperature, associated objects, and/or other color descriptions. A single preset color may correspond to one or multiple color description texts. In different embodiments, the color description texts for each preset color may be collected from internet data, literature, or art books. In some embodiments, the color description texts for each preset color may be generated using a large language model.

For example, Table 1 is a feature list of color semantic vectors for multiple preset colors. In this example, multiple preset colors are represented in the combination form of Hue (H), Chroma (C), and Value (V) as (H, C, V). As shown in Table 1, the first preset color (H1, C1, V1) may correspond to color semantic vectors V1 to V3 based on three color description texts. Similarly, the second preset color (H2, C2, V2) may correspond to color semantic vectors V4 to V5 based on two color description texts.

TABLE 1

| default color | color description text | color semantic vector |
|---|---|---|
| first default color | love | Color semantic vector V1 |
| (H1, C1, V1) | passionate | Color Semantic Vector V2 |
| | vivid red | Color semantic vector V3 |
| second default color | dark | Color Semantic Vector V4 |
| (H2, C2, V2) | Navy blue | Color Semantic Vector V5 |
| . . . | . . . | . . . |

In some embodiments, the processor 140 may utilize a large language model to generate color description texts for each preset color based on a preset prompt associated with each preset color. The aforementioned large language model may be, for example, a GPT model, but is not limited to this. For instance, the processor 140 may input a preset prompt associated with a certain preset color, such as “Please provide the feelings evoked by the preset color (H2, C2, V2)” into the GPT model, to have the GPT model output the color description text for the preset color (H2, C2, V2). Alternatively, the processor 140 may input a preset prompt associated with a certain preset color, such as “Please provide associated holidays or objects for the preset color (H2, C2, V2)” into the GPT model, to make the GPT model output the color description text for the preset color (H2, C2, V2).

In some embodiments, the processor 140 may collect color descriptions of multiple other preset colors in a second color system. The second color system is different from the first color system to which the multiple preset colors belong. The processor 140 may perform a color system conversion on the multiple other preset colors in the second color system to obtain the multiple preset colors in the first color system. For example, when the processor 140 obtains data including multiple RGB colors (i.e., multiple other preset colors) and corresponding color descriptions, the processor 140 may convert the multiple RGB colors in the RGB color system to the HCV (Hue, Chroma, Value) color space. Through this color system conversion, the three primary color value representations of RGB colors will be mapped to a color description method based on hue, chroma, and value, to obtain multiple preset colors.

In some embodiments, the processor 140 may generate the color description texts of the plurality of preset colors according to the color descriptions of the plurality of other preset colors, based on correspondence between the plurality of preset colors and the plurality of other preset colors. For example, when a first RGB color corresponds to a first preset color, the processor 140 may use one or more color descriptions of the first RGB color as one or more color description texts for the first preset color.

In some embodiments, when the first HCV color corresponding to the first RGB color is similar to the second HCV color corresponding to the second RGB color, the processor 140 may retain either the first HCV color or the second HCV color as one of the multiple preset colors. Furthermore, the color descriptions of the first RGB color and the second RGB color may be combined to serve as the color description texts for the retained first HCV color or second HCV color.

In step S420, the processor 140 may record the semantic vector of each of the preset colors to a database. The aforementioned database may be stored in a cloud server or the storage device 120 of the electronic device 100. In step S430, the processor 140 may receive user input information through the input device 110. In step S440, the processor 140 may generate a search semantic vector based on the user input information through a text embedding model. The detailed embodiment methods of the above steps may refer to the previously described embodiments, which will not be repeated here.

In step S450, the processor 140 may select at least one theme color from the multiple preset colors based on the search semantic vector and the color semantic vector of each of the multiple preset colors. In some embodiments, step S450 may be realized as steps S451 to S452.

In step S451, the processor 140 may calculate a semantic similarity between the search semantic vector and the color semantic vector of each preset color. In step S452, the processor 140 may select at least one theme color from the multiple preset colors based on the semantic similarity of each preset color. In other words, the processor 140 may select a theme color that matches the semantic of the user input information from the multiple preset colors based on one or more semantic similarities corresponding to each preset color.

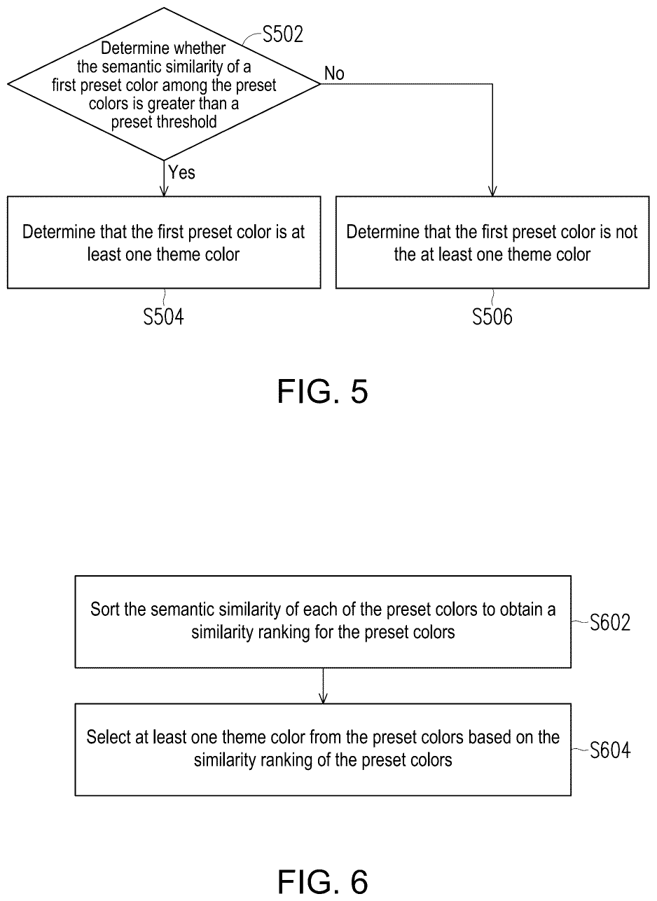

Referring to FIG. 5, in some embodiments, step S452 may be realized as steps S502 to S506. In step S502, the processor 140 may determine whether the semantic similarity of a first preset color among the multiple preset colors is greater than a preset threshold. For example, using Table 1 as an example, the processor 140 may determine whether the semantic similarity between the search semantic vector and each of the color semantic vectors V1 to V5 is greater than the preset threshold.

In step S504, when the semantic similarity of the first preset color among the multiple preset colors is greater than the preset threshold (step S502 determines yes), the processor 140 may determine that the first preset color is at least one theme color. In step S506, when the semantic similarity of the first preset color among the multiple preset colors is not greater than the preset threshold (step S502 determines no), the processor 140 may determine that the first preset color is not at least one theme color. The preset threshold may be set according to the actual application, and the disclosure does not limit this.

Referring to FIG. 6, in some embodiments, step S452 may be realized as steps S602 to S604. In step S602, the processor 140 may sort the semantic similarity of each of the preset color to obtain a similarity ranking for the preset colors. Specifically, the processor 140 may sort all the color semantic vectors in the database according to their corresponding semantic similarities from high to low. Based on the above sorting result of the color semantic vectors, the processor 140 may obtain the similarity ranking for each of these preset colors. For example, the similarity ranking of the preset colors can be derived directly from the order of their color semantic vectors in the sorted list. Alternatively, in some embodiments, processor 140 can determine the similarity ranking of each preset color based on multiple ranking orders corresponding to multiple color semantic vectors of each preset color. For instance, processor 140 can compute a similarity score for a given preset color based on multiple ranking orders of its associated color semantic vectors. The final similarity ranking of each preset color can then be determined based on these similarity scores.

In step S604, the processor 140 may select at least one theme color from the multiple preset colors based on the similarity ranking of the preset colors. For example, the processor 140 may choose the top X preset colors in the similarity ranking as the theme colors.

Referring to FIG. 4, in step S460, the processor 140 may execute an interface color setting function of the visual operation interface according to at least one theme color. In some embodiments, step S460 may be realized as steps S461 to S463.

In step S461, the processor 140 may determine a system color scheme including at least one secondary color and at least one theme color based on the at least one theme color and a color scheme mechanism. Specifically, in some embodiments, according to a predetermined color scheme mechanism, the processor 140 may generate a complete color palette (i.e., system color scheme) including the theme color and at least one secondary color based on a theme color. The theme color selected by the processor 140 may be the main color of the system color scheme. Additionally, the processor 140 may determine the secondary colors (such as accent colors, background colors, surface colors, or text colors, etc.) of the system color scheme according to the color scheme mechanism. The color scheme mechanism may be, Android's Dynamic Color mechanism, but is not limited to this.

In step S462, the processor 140 may provide a color setting option of the system color scheme in a color setting interface. The processor 140 may provide a color setting option based on the system color scheme in a color setting interface presented on the display 130, allowing the user to intuitively view and select different color configurations.

In step S463, the processor 140 may configure interface color of the visual operation interface according to the system color scheme. In response to the user executing a selection operation on a color setting option of a certain system color scheme, the processor 140 may configure the color style of the visual operation interface according to the selected system color scheme. In some embodiments, the processor 140 may set different areas or UI components of the visual operation interface respectively according to the theme color and secondary colors of the system color scheme. For example, the theme color may be used for the main background or title area of the interface, while secondary colors may be used for buttons, icons, sliders, and other interactive elements. Background colors and surface colors may be used for large background areas to enhance overall visual harmony, while text colors need to ensure sufficient contrast with the background to maintain good readability.

In summary, in the disclosure, a text embedding model may be utilized to generate a search semantic vector of the user input information, and compare the search semantic vector with color semantic vectors corresponding to each preset color to select at least one theme color matching the user input information from multiple preset colors. Subsequently, an interface color setting function of the visual operation interface may be executed according to the theme color. Based on this, the color scheme of the visual operation interface is no longer limited to fixed colors, but can select a color scheme that better matches the user's preferences based on the semantics of the user input information. Therefore, it can bring more diverse visual changes and interest, and experience the connection and interaction between the device and the user.

Although the invention has been disclosed in the above embodiments, it is not intended to limit the invention. Any person skilled in the art may make minor modifications and refinements without departing from the spirit and scope of the disclosure. Therefore, the protection scope of the disclosure should be defined by the appended claims.

What is claimed is:

1. A visual interface color setting method, adapted to an electronic device comprising a display configured to display a visual operation interface, the method comprising:
receiving a user input information;
generating a search semantic vector according to the user input information through a text embedding model;
selecting at least one theme color from a plurality of preset colors according to the search semantic vector and a color semantic vector of each of the plurality of preset colors; and
executing an interface color setting function of the visual operation interface according to the at least one theme color.

2. The visual interface color setting method as claimed in claim 1, wherein the step of selecting the at least one theme color from the plurality of preset colors according to the search semantic vector and the color semantic vector of each of the plurality of preset colors comprises:
calculating a semantic similarity between the search semantic vector and the color semantic vector of each of the plurality of preset colors; and
selecting the at least one theme color from the plurality of preset colors according to the semantic similarity of each of the plurality of preset colors.

3. The visual interface color setting method as claimed in claim 2, further comprising:
generating the color semantic vector by utilizing the text embedding model according to a color description text of each of the plurality of preset colors; and
recording the color semantic vector of each of the plurality of preset colors to a database.

4. The visual interface color setting method as claimed in claim 3, further comprising:
generating the color description text of each of the plurality of preset colors by utilizing a large language model according to a preset prompt associated with each of the plurality of preset colors.

5. The visual interface color setting method as claimed in claim 3, wherein the plurality of preset colors belong to a first color system, the method further comprising:
collecting color descriptions of a plurality of other preset colors in a second color system;
performing a color system conversion on the plurality of other preset colors in the second color system to obtain the plurality of preset colors in the first color system; and
generating the color description texts of the plurality of preset colors according to the color descriptions of the plurality of other preset colors, based on correspondence between the plurality of preset colors and the plurality of other preset colors.

6. The visual interface color setting method as claimed in claim 2, wherein the step of selecting the at least one theme color from the plurality of preset colors according to the semantic similarity of each of the plurality of preset colors comprises:
determining a first preset color as the at least one theme color when the semantic similarity of the first preset color among the plurality of preset colors is greater than a preset threshold.

7. The visual interface color setting method as claimed in claim 2, wherein the step of selecting the at least one theme color from the plurality of preset colors according to the semantic similarity of each of the plurality of preset colors comprises:
sorting the semantic similarity of each of the plurality of preset colors to obtain a similarity ranking of the plurality of preset colors; and
selecting the at least one theme color from the plurality of preset colors according to the similarity ranking of the plurality of preset colors.

8. The visual interface color setting method as claimed in claim 1, wherein the step of executing the interface color setting function of the visual operation interface according to the theme color comprises:
determining a system color scheme comprising at least one secondary color and the at least one theme color according to the at least one theme color and a color scheme mechanism; and
configuring interface color of the visual operation interface according to the system color scheme.

9. The visual interface color setting method as claimed in claim 1, wherein the step of executing the interface color setting function of the visual operation interface according to the theme color comprises:
determining a system color scheme comprising at least one secondary color and the at least one theme color according to the at least one theme color and a color scheme mechanism; and
providing a color setting option of the system color scheme in a color setting interface.

10. An electronic device, comprising:
an input device;
a display, configured to display a visual operation interface;
a storage device, recording a plurality of instructions;
a processor, coupled to the input device, the display and the storage device, executing the instructions and configured to:
receive a user input information;
generate a search semantic vector according to the user input information through a text embedding model;
select at least one theme color from a plurality of preset colors according to the search semantic vector and a color semantic vector of each of the plurality of preset colors; and
execute an interface color setting function of the visual operation interface according to the at least one theme color.
